(19) United States
(12) Patent Application Publication
(10) Pub. No.: US 2006/0277055 A1
(43) Pub. Date: Dec. 7, 2006

(54) Method for disc logistics with an RFID function

(76) Inventor: Liang Su, Miaoli Hsien (TW)

Correspondence Address: ROSENBERG, KLEIN & LEE, 3458 ELLICOTT CENTER DRIVE-SUITE 101, ELLICOTT CITY, MD, 21043, US

(21) Appl. No.: 11/143,469

(22) Filed: Jun. 3, 2005

(51) Int. Cl. G06Q 99/00

(52) U.S. Cl. 705/1

(57) ABSTRACT

A method for disc logistics with an RFID function is provided. The disc box with the RFID tag can not only be used to accommodate the at least one disc, but can also manage or quickly integrate the disc production processes and the disc logistics by using a reading device to read the RFID tag. Hence, using the disc box with the RFID tag not only increases internal working efficiency for manufacturers, but is also convenient for other enterprises (such as logistic centers, storage transfer centers, etc.) to exchange disc boxes or manage logistics for discs, so that the integration and efficiency of discs logistics will be increased. The disc box with the RFID tag has a feed back function for preventing errors from occurring in the disc production process and disc logistics.

### BACKGROUND OF THE INVENTION

1. Field of The Invention

The present invention relates to a method for disc logistics with an RFID function, and particularly relates to a method for integrating a manufacturer, a logistics center and a storage transfer center with each other via disc boxes with corresponding RFID tags.

2. Description of the Related Art

Logistics is a very important procedure in complex freight circulation. Freight can be circulated quickly between a production place and a demand place. A disc box manufactured by a regular disc factory is used to carry discs, in order to have at least one disc transported to its destination in the disc box. However, a regular disc box only has a carrying function, lacking the function of information management.

In general, the quantity of disc boxes held by a store or a warehouse for example, is conducted by manual counting, or by manually scanning the bar code on the disc boxes with a scanning device. However, these methods not only allow mistakes to be made easily, but also require a lot of time to ascertain the quantity of discs held. Moreover, it is impossible to manage the disc production process and the disc material flow with a regular disc. Disc information cannot be incorporated into a regular disc, so production costs are raised and manpower is wasted. Moreover, production processes and logistics processes for discs cannot be controlled, and an upstream and a downstream factory cannot be integrated with each other, so resources are wasted.

### SUMMARY OF THE INVENTION

The present invention provides a method for disc logistics with an RFID function. Because a disc box has a RFID tag inserted therein or attached thereon and the RFID tag has built-in disc related information, the disc box with the RFID tag can not only be used to accommodate the at least one disc, but can also manage or quickly integrate the disc production process and the disc logistics via using a reading device to read the RFID tag. Hence, using the disc box with the RFID tag not only increases internal working efficiency for manufacturers, but is also convenient for other enterprises (such as logistic centers, storage transfer centers, etc.) to exchange disc boxes or manage logistics for discs, so that the integration and efficiency of discs logistics will be increased. The disc box with the RFID tag has a feed back function for preventing errors occurring in the disc production process and disc logistics.

A disc box includes a main body and an RFID tag. The RFID tag is attached on or installed inside the main body. A disc box with an RFID tag can not only be used to accommodate a disc, but also to manage or quickly integrate the disc production process and the disc material flow, prevent errors from occurring in the disc production process and to provide a burglarproof function.

One aspect of the invention is a method for disc logistics with an RFID function. The method comprises providing a plurality of disc boxes with corresponding RFID tags, and a plurality of reading devices for reading the corresponding RFID tags, wherein each of the disc boxes is used to receive at least one disc, and each of the RFID tags has disc data corresponding to the at least one disc; controlling internal shipping processes of the disc boxes for integrally and rapidly managing shipping information of the disc boxes via reading the RFID tags of the disc boxes; controlling external logistic processes of the disc boxes for integrally and rapidly managing logistic information of the disc boxes and transmitting the disc boxes to a downstream retailer via reading the RFID tags of the disc boxes; and controlling external storage transfer processes of the disc boxes for integrally and rapidly managing storage transfer information of the disc boxes and transmitting the disc boxes to a freight distribution station via reading the RFID tags of the disc boxes.

Another aspect of the invention is a method for disc logistics with an RFID function. The method comprises producing a plurality of disc boxes with corresponding RFID tags via a disc box manufacturer; providing the disc boxes with the corresponding RFID tags to a disc manufacturer from the disc box manufacturer for receiving discs and controlling production and shipping process of the discs via reading the RFID tags of the disc boxes; and transmitting the disc boxes with the corresponding RFID tags to a downstream retailer and a freight distribution station via a logistics center and a storage transfer center, respectively.

Other aspect of the invention is a method for disc logistics with an RFID function. The method comprises producing a plurality of disc boxes with corresponding RFID tags via a disc box manufacturer; providing the disc boxes with the corresponding RFID tags to a disc box rental company from the disc box manufacturer; providing the disc boxes with the corresponding RFID tags to a disc manufacturer from the disc box rental company for receiving discs and controlling production and shipping process of the discs via reading the RFID tags of the disc boxes; and transmitting the disc boxes with the corresponding RFID tags to a downstream retailer and a freight distribution station via a logistics center and a storage transfer center, respectively.

It is to be understood that both the foregoing general description and the following detailed description are exemplary, and are intended to provide further explanation of the invention as claimed. Other advantages and features of the invention will be apparent from the following description, drawings and claims.

### BRIEF DESCRIPTION OF THE DRAWINGS

The various objectives and advantages of the present invention will be more readily understood from the following detailed description when read in conjunction with the appended drawing, in which:

FIG. 1 is a block diagram of a method for disc logistics with an RFID function according to the first embodiment of the present invention;

FIG. 2 is a flowchart of a method for disc logistics with an RFID function according to the first embodiment of the present invention;

FIG. 3 is a block diagram of a method for disc logistics with an RFID function according to the second embodiment of the present invention;

FIG. 4 is a flowchart of a method for disc logistics with an RFID function according to the second embodiment of the present invention;

FIG. 5 is a flowchart of a method for disc logistics with an RFID function according to the third embodiment of the present invention;

FIG. 6 is a flowchart of a method for disc logistics with an RFID function according to the fourth embodiment of the present invention;

FIG. 7 is a flowchart of a method for disc logistics with an RFID function according to the fifth embodiment of the present invention; and

FIG. 8 is a flowchart of a method for disc logistics with an RFID function according to the sixth embodiment of the present invention.

### DETAILED DESCRIPTION OF PREFERRED EMBODIMENTS

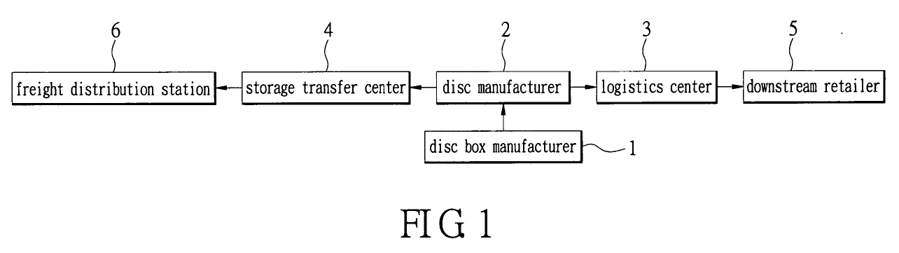

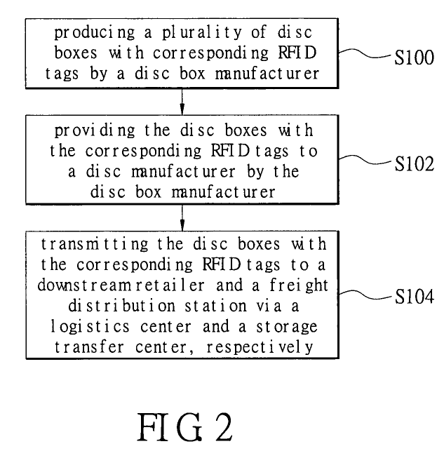

FIGS. 1 and 2 show a block diagram and a flowchart of a method for disc logistics with an RFID function according to the first embodiment of the present invention, respectively. The present invention provides a method for disc logistics with an RFID function. The method comprises the following steps. First, a plurality of disc boxes with corresponding RFID tags are produced by a disc box manufacturer 1 (S100). The disc boxes with the corresponding RFID tags are provided to a disc manufacturer 2 by the disc box manufacturer 1 (S102) for receiving discs and controlling production and shipping processes of the discs via the RFID tags of the disc boxes. Finally, the disc boxes with the corresponding RFID tags are transmitted to a downstream retailer 5 and a freight distribution station 6 via a logistics center 3 and a storage transfer center 4, respectively (S104).

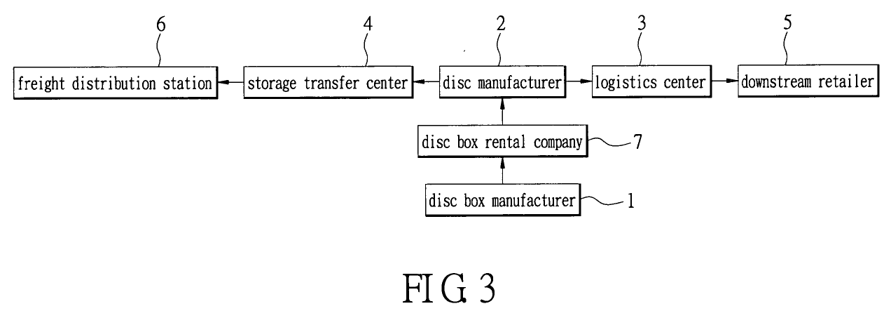

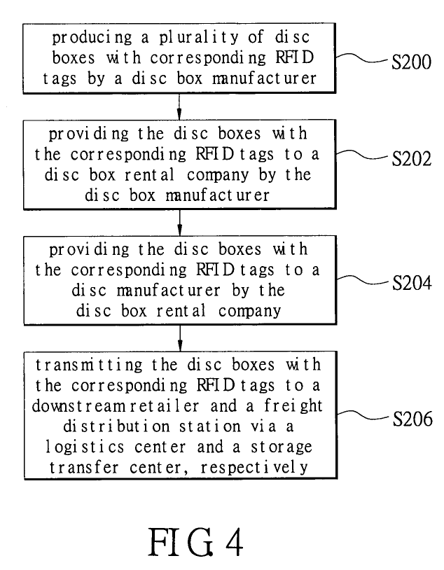

FIGS. 3 and 4 show a block diagram and a flowchart of a method for disc logistics with an RFID function according to the second embodiment of the present invention, respectively. The second embodiment includes a disc box rental company 7 between the disc box manufacturer 1 and the disc manufacturer 2 for increasing the number of choices available to users when they decide to rent or buy discs. The present invention provides a method for disc logistics with an RFID function. The method comprises the following steps. First, a plurality of disc boxes with corresponding RFID tags are produced by a disc box manufacturer 1 (S200). The disc boxes with the corresponding RFID tags are provided to a disc box rental company 7 by the disc box manufacturer 1 (S202). The disc boxes with the corresponding RFID tags are provided to a disc manufacturer 2 by the disc box rental company 7 (S204) for receiving discs and controlling production and shipping processes of the discs via reading the RFID tags of the disc boxes. Finally, the disc boxes with the corresponding RFID tags are transmitted to a downstream retailer 5 and a freight distribution station 6 via a logistics center 3 and a storage transfer center 4, respectively (S206).

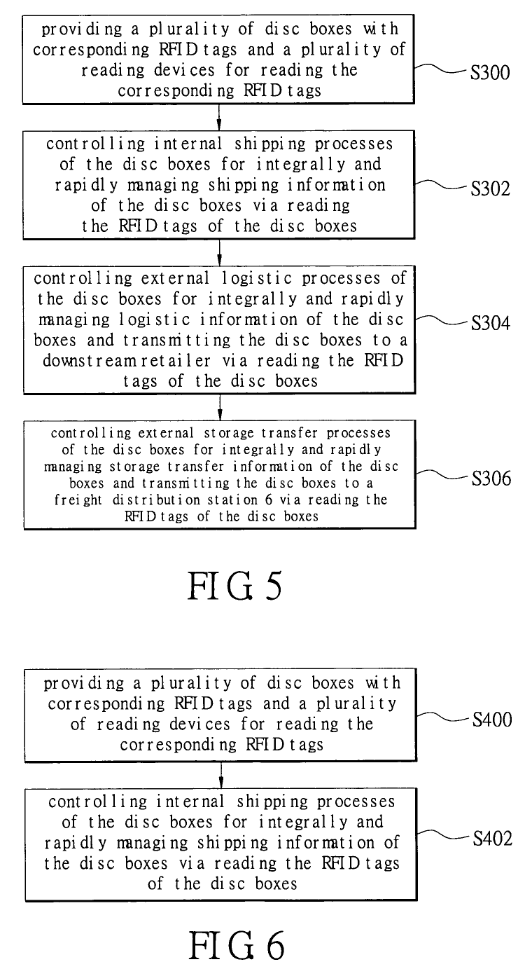

FIG. 5 shows a flowchart of a method for disc logistics with an RFID function according to the third embodiment of the present invention. The third embodiment of the present invention provides a method for disc logistics with an RFID function. The method comprises the following steps. First, a plurality of disc boxes with corresponding RFID tags and a plurality of reading devices for reading the corresponding RFID tags are provided, wherein each of the disc boxes is used to receive at least one disc, and each of the RFID tags has disc data corresponding to the at least one disc (S300).

Moreover, the disc box can be a VCD box, a DVD box, a multi-disc box or any boxes for receiving discs. The RFID tag can be installed inside the corresponding disc box by an embedding method or an injection molding method, or the RFID tag can be attached onto the disc box by a sticking method or a printing method. However, the above-mentioned methods do not limit the present invention.

Furthermore, the RFID tag has built-in disc data that is convenient for users to search for discs, put discs in order and classify discs. The disc data comprises the quantity of discs, disc marks, disc speed, +R/−R disc, R/RW disc, number of layers and sides (including single-layer single-side, dual-layers single-side, single-layer dual-sides, and dual-layers dual-sides) of discs, and disc capacity. In order to use the reading device in different ways (point scan or non-point scan) to obtain the disc's related information, the reading device can be a PC, a portable computer or a PDA (Personal Digital Assistant) according to the user's preference.

Thereafter, internal shipping processes of the disc boxes are controlled for integrally and rapidly managing shipping information of the disc boxes via reading the RFID tags of the disc boxes (S302). Step S302 further comprises feeding back the shipping information to a disc manufacturer 2 via reading the RFID tags of the disc boxes and a network system.

Furthermore, external logistic processes of the disc boxes are controlled for integrally and rapidly managing logistic information of the disc boxes and transmitting the disc boxes to a downstream retailer 5 via reading the RFID tags of the disc boxes (S304). Step S304 further comprises feeding back the logistic information to a disc manufacturer 2 and a logistics center 3 via reading the RFID tags of the disc boxes and a network system.

Moreover, external storage transfer processes of the disc boxes are controlled for integrally and rapidly managing storage transfer information of the disc boxes and transmitting the disc boxes to a freight distribution station 6 via reading the RFID tags of the disc boxes (S306). Step S306 further comprises feeding back the storage transfer information to a disc manufacturer 2 and a storage transfer center 4 via reading the RFID tags of the disc boxes and a network system. Hence, using the disc box with the RFID tag not only increases internal working efficiency for manufacturers, but is also convenient for other enterprises (such as logistic centers, storage transfer centers, etc.) to exchange disc boxes or manage logistics for discs, so that the integration and efficiency of discs logistics will be increased. The disc box with the RFID tag has a feed back function for preventing errors occurring in the disc production process and disc logistics.

FIG. 6 shows a flowchart of a method for disc logistics with an RFID function according to the fourth embodiment of the present invention. Steps S400 and S402 of the fourth embodiment are the same as steps S300 and S302 of the third embodiment, respectively. The fourth embodiment is used to increase internal working integration and efficiency for manufacturers.

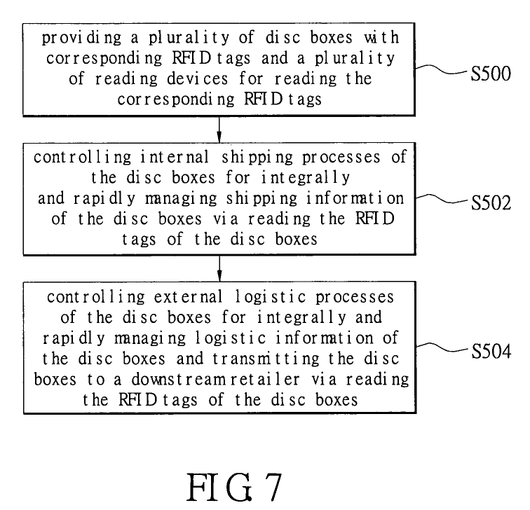

FIG. 7 shows a flowchart of a method for disc logistics with an RFID function according to the fifth embodiment of the present invention. Steps S500, S502 and S504 of the fifth embodiment are the same as steps S300, S302 and S304 of the third embodiment, respectively. The fifth embodiment is used to not only increase internal working integration and efficiency for manufacturers, but also to integrate the manufacturer and the logistics center for increasing logistics integration and efficiency between the manufacturer and the logistics center.

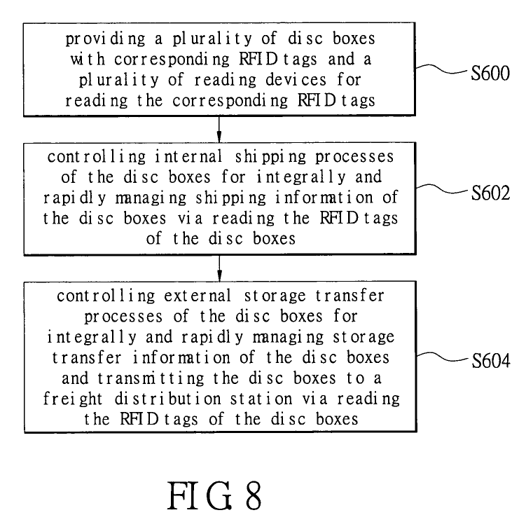

FIG. 8 shows a flowchart of a method for disc logistics with an RFID function according to the sixth embodiment of the present invention. Steps S600, S602 and S604 of the sixth embodiment are the same as steps S300, S304 and S306 of the third embodiment, respectively. The sixth embodiment is used to not only increase internal working integration and efficiency for manufacturers, but also to integrate the manufacturer and the storage transfer center for increasing logistics integration and efficiency between the manufacturer and the storage transfer center.

In conclusion, because the disc box has an RFID tag with built-in disc related information, the disc box with the RFID tag can not only be used to accommodate the at least one disc, but it can also manage or quickly integrate the disc production processes and the disc logistics by using a reading device to read the RFID tag. Hence, using the disc box with the RFID tag not only increases internal working efficiency for manufacturers, but is also convenient for other enterprises (such as logistic centers, storage transfer centers, etc.) to exchange disc boxes or manage logistics for discs, increasing integration and efficiency of discs logistics. The disc box with the RFID tag has a feed back function for preventing errors from occurring in disc production processes and disc logistics.

Although the present invention has been described with reference to the preferred embodiments thereof, it will be understood that the invention is not limited to the details thereof. Various substitutions and modifications have been suggested in the foregoing description, and others will occur to those of ordinary skill in the art. Therefore, all such substitutions and modifications are intended to be embraced within the scope of the invention as defined in the appended claims.

What is claimed is:

1. A method for disc logistics with an RFID function, comprising:
providing a plurality of disc boxes with corresponding RFID tags, and a plurality of reading devices for reading the corresponding RFID tags, wherein each of the disc boxes is used to receive at least one disc, and each of the RFID tags has disc data corresponding to the at least one disc;
controlling internal shipping processes of the disc boxes for integrally and rapidly managing shipping information of the disc boxes via reading the RFID tags of the disc boxes;
controlling external logistic processes of the disc boxes for integrally and rapidly managing logistic information of the disc boxes and transmitting the disc boxes to a downstream retailer via reading the RFID tags of the disc boxes; and
controlling external storage transfer processes of the disc boxes for integrally and rapidly managing storage transfer information of the disc boxes and transmitting the disc boxes to a freight distribution station via reading the RFID tags of the disc boxes.

2. The method as claimed in claim 1, wherein the disc box is a VCD box, a DVD box or a multi-disc box.

3. The method as claimed in claim 1, wherein the RFID tag is installed inside the corresponding disc box by an embedding method.

4. The method as claimed in claim 1, wherein the RFID tag is installed inside the corresponding disc box by an injection molding method.

5. The method as claimed in claim 1, wherein the RFID tag is attached onto the disc box by a sticking method.

6. The method as claimed in claim 1, wherein the RFID tag is attached onto the disc box by a printing method.

7. The method as claimed in claim 1, wherein the disc data comprises: quantity of disc, disc mark, disc speed, +R/−R disc, R/RW disc, number of layers and sides of disc, and disc capacity.

8. The method as claimed in claim 7, wherein the number of layers and sides comprises: single-layer single-side, dual-layers single-side, single-layer dual-sides, and dual-layers dual-sides.

9. The method as claimed in claim 1, wherein the reading device is a PC, a portable computer or a PDA.

10. The method as claimed in claim 1, wherein the step of controlling the internal shipping processes of the disc boxes further comprises: feeding back the shipping information to a disc manufacturer via reading the RFID tags of the disc boxes and a network system.

11. The method as claimed in claim 1, wherein the step of controlling external logistic processes of the disc boxes further comprises: feeding back the logistic information to a disc manufacturer and a logistics center via reading the RFID tags of the disc boxes and a network system.

12. The method as claimed in claim 1, wherein the step of controlling an external storage transfer process of the disc boxes further comprises: feeding back the storage transfer information to a disc manufacturer and a storage transfer center via reading the RFID tags of the disc boxes and a network system.

13. A method for disc logistics with an RFID function, comprising:
producing a plurality of disc boxes with corresponding RFID tags by a disc box manufacturer;
providing the disc boxes with the corresponding RFID tags to a disc manufacturer from the disc box manufacturer for receiving discs and controlling production and shipping processes of the discs via reading the RFID tags of the disc boxes; and
transmitting the disc boxes with the corresponding RFID tags to a downstream retailer and a freight distribution station via a logistics center and a storage transfer center, respectively.

14. The method as claimed in claim 13, wherein the RFID tag is installed inside the corresponding disc box by an embedding method.

15. The method as claimed in claim 13, wherein the RFID tag is installed inside the corresponding disc box by an injection molding method.

16. The method as claimed in claim 13, wherein the RFID tag is attached onto the disc box by a sticking method.

17. The method as claimed in claim 13, wherein the RFID tag is attached onto the disc box by a printing method.

18. The method as claimed in claim 13, wherein the disc data comprises: quantity of disc, disc mark, disc speed, +R/−R disc, R/RW disc, number of layers and sides of disc, and disc capacity.

19. The method as claimed in claim 13, wherein the reading device is a PC, a portable computer or a PDA.

20. A method for disc logistics with an RFID function, comprising:
producing a plurality of disc boxes with corresponding RFID tags by a disc box manufacturer;
providing the disc boxes with the corresponding RFID tags to a disc box rental company from the disc box manufacturer;
providing the disc boxes with the corresponding RFID tags to a disc manufacturer from the disc box rental company for receiving discs and controlling production and shipping processes of the discs via reading the RFID tags of the disc boxes; and
transmitting the disc boxes with the corresponding RFID tags to a downstream retailer and a freight distribution station via a logistics center and a storage transfer center, respectively.
